(19) United States
(12) Patent Application Publication
(10) Pub. No.: US 2020/0082325 A1
(43) Pub. Date: Mar. 12, 2020

(54) MOVEABLE ASSET TRACKING SYSTEMS USING CROWDSOURCING MEASUREMENTS

(71) Applicant: Capital One Services, LLC, McLean, VA (US)

(72) Inventors: Stephen Michael Wylie, Carrollton, TX (US); Jason Richard Hoover, Grapevine, TX (US); Geoffrey Dagley, McKinney, TX (US); Micah Price, Plano, TX (US); Qiaochu Tang, The Colony, TX (US)

(21) Appl. No.: 16/129,272

(22) Filed: Sep. 12, 2018

(51) Int. Cl. G06Q 10/08; H04W 4/029; H04W 4/80; H04W 40/24; G08G 1/00

(52) U.S. Cl. CPC G06Q 10/087; H04W 4/029; G08G 1/20; H04W 40/244; H04W 4/80

(57) ABSTRACT

The disclosed invention includes methods and systems for tracking a moveable asset. Embodiments include receiving, from a stationary receiver, an indication of a first signal strength of a beacon signal originating from a beacon attached to a moveable asset, and an identifier of the beacon signal. A first mobile computing device may receive an indication of a second signal strength of the beacon signal, the identifier of the beacon signal, and an indication of a location of the first mobile computing device. A normalized signal strength corresponding to the identifier may be determined based on dividing the indication of the second signal strength by the indication of the first signal strength. A location of the moveable asset may be determined based at least in part on the normalized signal strength and indication of the location of the first mobile computing device.

### FIELD

The disclosed technology generally relates to the field of asset tracking and, more particularly, to systems and methods for determining locations of moveable assets using crowdsourcing measurements.

### BACKGROUND

When a car buyer visits a car dealership lot to physically inspect a vehicle for potential purchase, there are often numerous other vehicles on the lot, which can make locating a particular vehicle a time consuming and frustrating process. Often vehicles are delivered or returned after being test driven and parked in the closest available spaces with little regard to an order that would make it easy for customers to find a particular vehicle. While seemingly convenient for the customer or employee on the test drive, this presents a challenge for the next customer(s) to find that vehicle on the dealer lot even if they have already identified it as a vehicle of interest. Even worse, future customer(s) in search of suitable vehicles are left wandering around the dealer lot to find one and, when they do, are unsure as to the location or existence of similar vehicles. Customers are also forced to rely on window stickers to provide pricing and other detailed vehicle information during their search.

Accordingly, there is a need for improved systems and methods for locating such moveable assets. Embodiments of the present disclosure are directed to this and other considerations.

### SUMMARY

The disclosed technology includes moveable asset tracking systems for determining the approximate location of a moveable asset (e.g., a vehicle on a dealer lot) using crowdsourced measurements of signals emitted from a beacon attached to the moveable asset. The beacon, for example, may be configured to transmit a beacon signal that can be detected by mobile computing devices, such as smartphones having Bluetooth® and GPS receivers. The beacon signal emitted from the beacon includes a beacon ID that can be associated with a particular moveable asset, and the strength of the received beacon signal can be utilized as an indication of the proximity of the moveable asset to the user's smartphone. Certain example implementations of the disclosed technology may further include a stationary receiver that may simultaneously measure the beacon signal to establish a reference signal power to compensate for signal strength fluctuations that could introduce errors in the determined location of the moveable asset. In accordance with certain example implementations of the disclosed technology, the accuracy of the determined location of the moveable asset may be refined and updated as additional measurements are made from additional positions near the asset.

Consistent with the disclosed embodiments, methods and non-transitory computer-readable mediums for determining the approximate location of a moveable asset using crowdsourced measurements are also disclosed.

Further features of the disclosed design, and the advantages offered thereby, are explained in greater detail hereinafter with reference to specific embodiments illustrated in the accompanying drawings, wherein like elements are indicated be like reference designators.

### BRIEF DESCRIPTION OF THE FIGURES

Reference will now be made to the accompanying figures and flow diagrams, which are not necessarily drawn to scale, and which are incorporated into and constitute a portion of this disclosure, illustrate various implementations and aspects of the disclosed technology and, together with the description, serve to explain the principles of the disclosed technology.

FIG. 1 depicts an overhead side view of an asset area in which signals transmitted by beacon-equipped vehicles are detectable by nearby smartphones and a stationary receiver, according to an example implementation of the disclosed technology.

FIG. 2 depicts an example block diagram of an asset tracking system, according to an example implementation of the disclosed technology.

FIG. 3 is a block diagram of an illustrative computing device, according to an example implementation of the disclosed technology.

FIG. 4A depicts an example representation of normalized beacon signal strength as a function of distance (x, y) from a beacon, according to an example implementation of the disclosed technology.

FIG. 4B depicts a top-view representation of paths traversed near a beacon 406, according to an example implementation of the disclosed technology.

FIG. 4C depicts normalized signal strength measurements near a beacon as a function of the paths illustrated in FIG. 4B, according to an example implementation of the disclosed technology.

FIG. 5 is a flow diagram of a method for asset tracking, according to an example implementation of the disclosed technology.

FIG. 6 is a flow diagram of another method for asset tracking, according to an example implementation of the disclosed technology.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The disclosed technology includes systems and methods for tracking a moveable asset. In certain example embodiments, the system can include a beacon attached to the moveable asset, wherein the beacon is configured to periodically transmit a beacon signal comprising an identifier. The system can further include at least one stationary receiver configured to: receive the beacon signal, determine a first signal strength of the beacon signal corresponding to the beacon signal received at the stationary receiver, and output reference data. The output reference data may include a beacon ID corresponding to the identifier and an indication of the determined first signal strength. The system may be configured to communicate with a first mobile computing device configured to: receive the beacon signal; determine a second signal strength of the beacon signal corresponding to the beacon signal received at the first mobile computing device, determine a location of the first mobile computing device, and output measurement data. The output measurement data may include a beacon ID corresponding to the identifier, an indication of the second signal strength, and an indication of the location of the first mobile computing device. The system may further include a signal strength measurement module having at least one processor in communication with memory and further in communication with the at least one stationary receiver and the at least one mobile receiver. The signal strength measurement module may be configured to: receive the reference data, receive the measurement data, and determine, with the at least one processor, an indication of normalized signal strength corresponding to the beacon ID based on dividing the first signal strength of the measurement data by the second signal strength of the reference data. The system may further include an asset location module in communication with the signal strength measurement module and the at least one processor. The asset location module may be configured to: receive the location indication of the at least one first mobile computing device; determine, with the at least one processor, a location of the moveable asset based at least in part on the indication of the normalized signal strength and the location indication of one or more of the first mobile computing device and a second mobile computing device; and output, for display, an indication of the location of the moveable asset.

In accordance with certain example implementations of the disclosed technology, a method is provided for tracking a moveable asset. The method includes receiving, from a stationary receiver: an indication of a first signal strength of a beacon signal originating from a beacon attached to a moveable asset, and an identifier of the beacon signal. The method further includes receiving, from a first mobile computing device: an indication of a second signal strength of the beacon signal, the identifier of the beacon signal, and an indication of a location of the first mobile computing device. The method further includes storing, in memory: reference data that includes the identifier, the indication of the first signal strength, and measurement data, which may include the identifier, the indication of the second signal strength, and the indication of the location of the first mobile computing device. The method further includes determining a normalized signal strength corresponding to the identifier and based on dividing the indication of the second signal strength by the indication of the first signal strength, determining a location of the moveable asset based at least in part on the normalized signal strength and indication of the location of the first mobile computing device, and outputting, for display on one or more of the first mobile computing device and a second mobile computing device, an indication of the location of the moveable asset.

Another method for tracking a moveable asset is disclosed herein. The method includes receiving, at a stationary receiver and at a first mobile computing device, a beacon signal comprising an identifier and from a beacon attached to the moveable asset, and determining a first signal strength of the beacon signal corresponding to the beacon signal received at the stationary receiver. The method also includes determining a second signal strength of the beacon signal corresponding to the beacon signal received at the first mobile computing device, and determining a location of the first mobile computing device. The method further includes storing, in memory: reference data, including: a beacon ID corresponding to the identifier, an indication of the determined first signal strength, and measurement data. The measurement data may include a beacon ID corresponding to the identifier, an indication of the second signal strength, and an indication of the location of the first mobile computing device. The method further includes determining a normalized signal strength corresponding to the beacon ID and based on dividing the first signal strength of the measurement data by the second signal strength of the reference data, and determining a location of the moveable asset based at least in part on the indication of the normalized signal strength and the location indication of the first mobile computing device. Further, the method includes outputting, for display on one or more of the first mobile computing device and a second mobile computing device, an indication of the location of the moveable asset.

The disclosed technology further provides a non-transitory computer readable storage medium storing instructions for use with a moveable asset locator system. The instructions are configured to cause the system to perform a method that includes receiving, from a stationary receiver: an indication of a first signal strength of a beacon signal originating from a beacon attached to a moveable asset; and an identifier of the beacon signal, and receiving, from a first mobile computing device: an indication of a second signal strength of the beacon signal, the identifier of the beacon signal, and an indication of a location of the first mobile computing device. The method also includes storing, in memory: reference data, including: the identifier, the indication of the first signal strength, and measurement data. The measurement data may include the identifier, the indication of the second signal strength, and the indication of the location of the first mobile computing device. The method further includes determining a normalized signal strength corresponding to the identifier and based on dividing the indication of the second signal strength by the indication of the first signal strength, determining a location of the moveable asset based at least in part on the normalized signal strength and indication of the location of the first mobile computing device, and outputting, for display on one or more of the first mobile computing device and a second mobile computing device, an indication of the location of the moveable asset.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

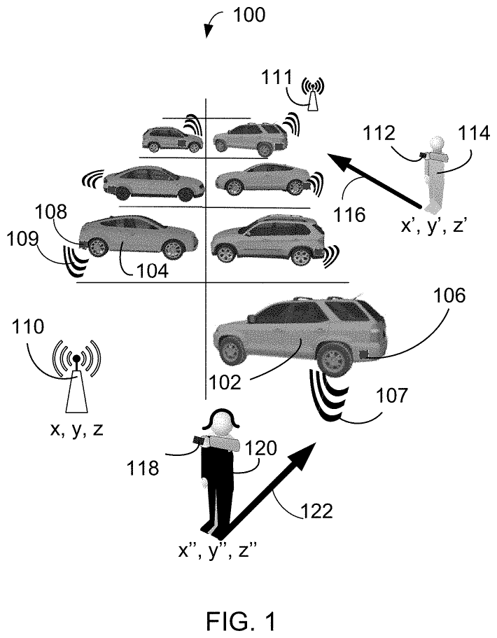

FIG. 1 depicts an example scenario 100 in which vehicles 102, 104 are equipped with respective beacons 106, 108 that transmit respective beacon signals 107, 109 that are detectable by nearby mobile computing devices (e.g., smartphones) 112, 118 and one or more stationary receivers 110, 111, according to an example implementation of the disclosed technology. Certain example implementations of the disclosed technology may leverage the ubiquitous use of smartphones having Bluetooth®, GPS, and/or other standard receivers to contribute (via crowdsourcing) to measurement data that can be used to determine approximate locations of the respective vehicles 102, 104 and/or other assets. It should be appreciated that the disclosed technology may be applied to many other tracking applications and is not limited to vehicle tracking, as illustrated in the example use case scenario 100. In certain example implementations, the beacons 106, 108 may be low energy Bluetooth® (BLE) beacons that can be configured to periodically (for example, every 100 ms, every 500 ms, once per second, etc.,) broadcast corresponding beacon IDs that may uniquely identify the asset to which they are attached.

One of the known issues with certain transmitted beacon signals 107, 109 is that the associated power of the signal can vary with time. In some BLE transmitters, the signal output power can vary by a few decibels over time. For example, some transmitters may output signals having a variable power output such as stairstep function over an approximate 20 s period. According to an example implementation of the disclosed technology, the stationary receiver 110 may receive the associated beacon signal(s) 107, 109 (including the associated beacon IDs) and determine the associated reference signal strengths as a function of time. Such reference signals may be utilized to normalize the measured signal strengths received from the smartphones 112, 118 to account for the beacon signal output power variations.

In accordance with certain example implementations of the disclosed technology, the signal strength may be measured/indicated by a Received Signal Strength Indicator (RSSI) corresponding to the signal strength as measured on the receiving device, e.g. a smartphone or stationary receiver. In certain example implementations, the RSSI may range from 0-255. In certain example implementations, the measured signal strength depends on the distance from the beacon, and on the beacon's broadcasting power value. For example, at maximum broadcasting power (+4 dBm) the RSSI may range from 225 (a few inches away from the beacon) to 100 or less (40-50 m away from the beacon). Due to external factors influencing radio waves (such as absorption, interference, or diffraction) RSSI tends to fluctuate. In some instances, the further away the device is from the beacon, the more unstable RSSI becomes.

As depicted in FIG. 1, and according to an example implementation of the disclosed technology, a stationary receiver 110 may be located at a first position (x, y, z) and within range of at least one of the beacons 106, 108. A first user 114 may carry a smartphone 112 and may be initially located at a second position (x′, y′, z′) and may receive beacon signals (such as beacon signals 107, 109, etc.,) that are broadcast from one or more respective beacons (such as beacons 106, 108, etc.). The first user 114 may traverse along a path 116 while receiving the beacon signals at the smartphone 112. In certain example implementations, the smartphone 112 may also determine its location at points along the path 116, for example, via GPS while also receiving the one or more beacon signals for which the corresponding RSSI may be determined.

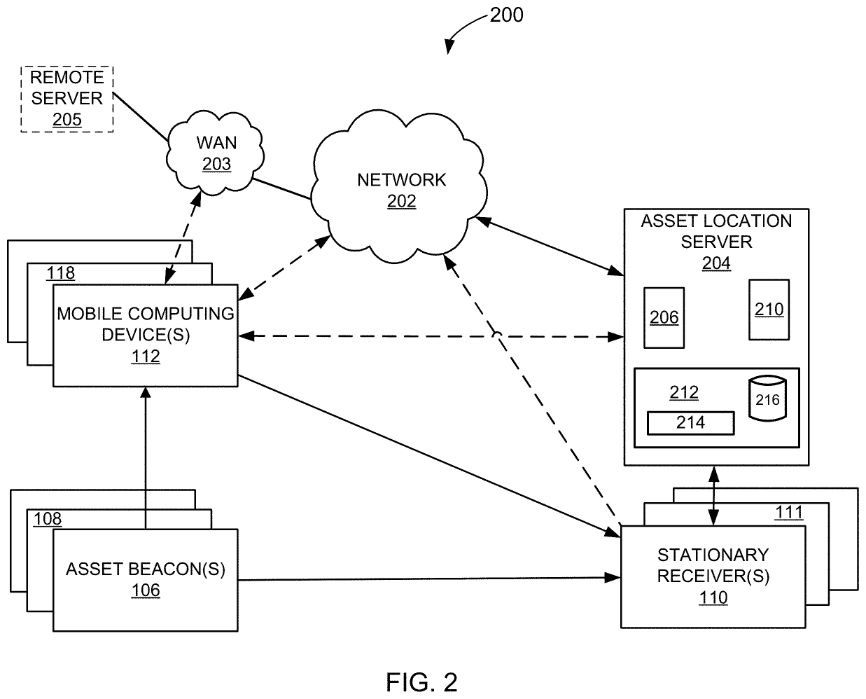

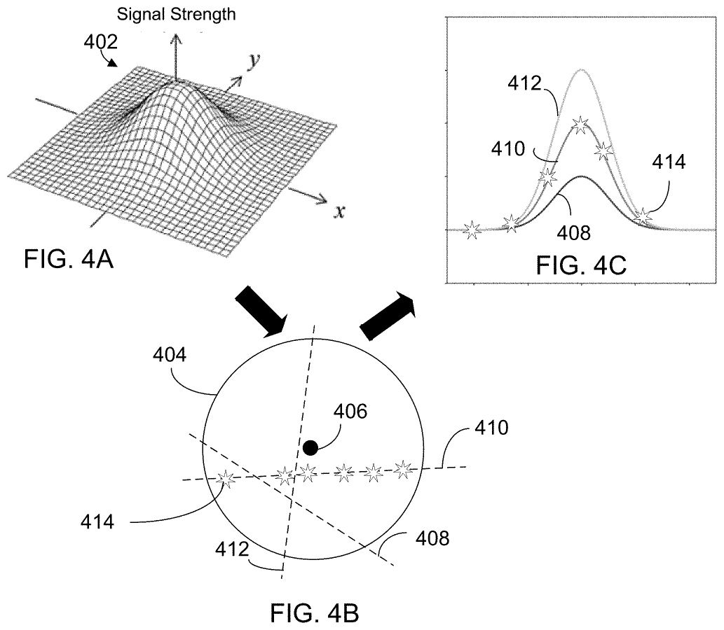

In accordance with an example implementation, and as will be discussed further with respect to FIG. 2 below, the stationary receiver 110 and the smartphone 112 may be in communication with an asset location server, for which respective information may be transmitted and utilized to identify the asset to which the associated beacon is attached, and to use the normalized beacon signal (for example, as the user 114 traverses the path 116) along with the corresponding location information of the smartphone 112 to provide information for inferring the location of the associated asset, as will be further explained below with reference to FIG. 4.

With continued reference to FIG. 1, and in accordance with certain example implementations of the disclosed technology, a second user 120 may carry a smartphone 118, and may be initially located at a third position (x″, y″, z″) and may receive beacon signals (such as beacon signals 107, 109, etc.) that are broadcast from one or more respective beacons (such as beacons 106, 108, etc.). The second user 120 may traverse along a second path 122 while receiving the beacon signals at their smartphone 118. In certain example implementations, the smartphone 118 may also determine its instantaneous location, for example, via GPS at the third location (x″, y″, z″) and at subsequent locations along the path 122 while also receiving the one or more beacon signals. Similarly, as discussed above, the smartphone 118 of the second user 120 may be in communication with the asset location server, for which respective information may be transmitted and utilized to further identify the asset to which the associated beacon is attached, and to use a second normalized beacon signal (for example, as the second user 120 traverses the path 122) along with the corresponding location (GPS) information of the smartphone 118 to provide information for inferring the location of the associated asset.

In accordance with certain example implementations of the disclosed technology, additional stationary receivers 111 may be distributed in the area, for example, to provide coverage for additional asset beacons that may be out of range of the first stationary receiver 110.

FIG. 2 depicts an example block diagram of an asset tracking system 200, according to an example implementation of the disclosed technology. The mobile computing devices 112, 118, the asset beacons 106, 108, and the stationary receivers 110, 111 as shown in FIG. 2 may correspond to like components as discussed above with reference to FIG. 1. In an example implementation, the system 200 may also include a network 202, which may include a wired and/or wireless local area network (LAN) capable of communicating with one or more of the components as discussed above.

In certain example implementations of the disclosed technology, the network 202 may also be in communication with a remote server 205 via a wide area network 203 (WAN) such as via the Internet. The remote server 205, for example, may provide additional processing, inventory control, software updates, etc., for use with the asset location server 204.

Certain example implementations of the disclosed technology may be configured to provide asset location information to a mobile computing device 112, for example, so that a particular asset may be easily located by a user, and/or so that assets located within a predetermined range of the mobile computing device 112 may be easily identified. A customer shopping for a vehicle, for example, may utilize their mobile computing device 112 to interact with the asset location server 204 (via the network 202, WAN 203, local access point(s), etc.) and receive asset location information and/or directions based on known or estimated coordinates of the asset position and GPS coordinates determined by the mobile computing device 112.

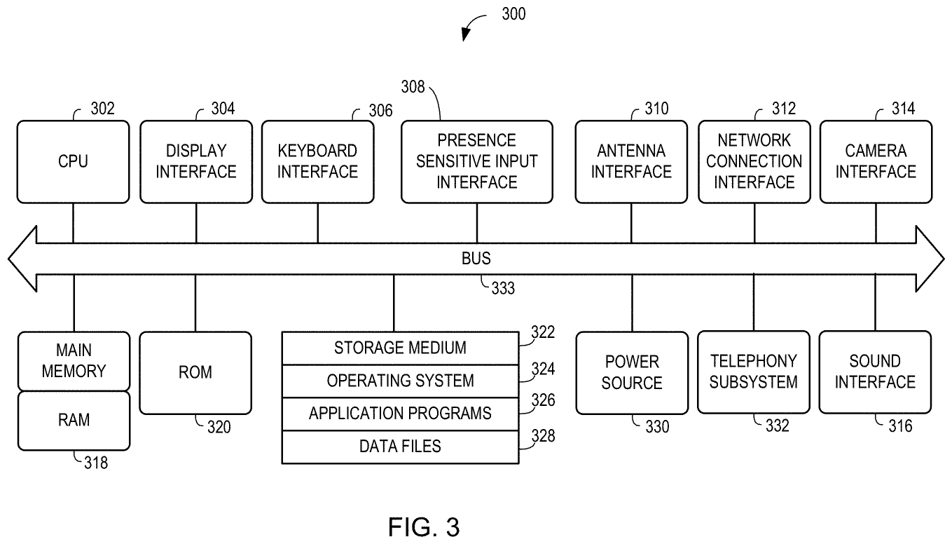

In accordance with certain example implementations of the disclosed technology, the asset location server 204 may include one or more processors 206 (and additional components as will be discussed below with reference to FIG. 3) and memory 210 storing instructions that cause the one or more processors 206 to perform various functions that enable determining locations of assets. In certain example implementations, the asset location server 204 may include location determination component 212 configured to process data received from the mobile computing device(s) 112, 118 and the stationary receiver(s) 110, 111. For example, the location determination component 212 may include one or more special purpose modules 214, including but not limited to a trained neural network and/or artificial intelligence module. In an example implementation, location determination component 212 may include memory 216 configured for storing updated location information of the various assets and/or detailed information related to particular make/year/model features, pricing, etc., of the asset. In certain example implementations, the memory 216 may be in the form of a location database having in-memory cache such as Redis or a traditional on-device database such as MySQL or MS SQL, a NoSQL type of unstructured database, and/or a cloud database service such as RDS or Firebase. Certain example implementations of the disclosed technology may utilize the asset location server 204 and/or associated components to determine the location of the asset beacons 106, 108 as will be further discussed with reference to FIG. 4 below.

Certain example implementations of the disclosed technology may utilize location information (such as GPS coordinates, geofencing, etc.,) to provide enhancements to the process of asset location determination. For example, a GPS receiver on the user's mobile computing device 112 may be utilized to determine an approximate location for which nearby assets may be identified. In one example scenario, a user may be walking around a car dealership lot. In certain example implementations, the user's mobile computing device 112 may access and utilize data from an inventory management system and may use the location information to filter and/or exclude vehicles based on location, for example, to exclude vehicles that are not expected to be present at or near that location. In another example scenario, location information from the user device 112 may be utilized to indicate a subset of vehicles that are likely to be nearby based on the location data. In certain example implementations of the disclosed technology, signage, QR codes, barcodes, emblems, and/or other identifying features near or attached to the vehicle may be utilized to enhance the location information.

FIG. 3 depicts a block diagram of an illustrative computing device 300 according to an example implementation. Certain aspects of FIG. 3 may be embodied in the asset location server 204 as discussed above with respect to FIG. 2. According to one example implementation, the term “computing device,” as used herein, may be a CPU, or conceptualized as a CPU (for example, the CPU 302 of FIG. 3). In this example implementation, the computing device (CPU) may be coupled, connected, and/or in communication with a network via communication channels including, but not limited to Internet connections, satellite communications, wireless channels, cloud connections, etc.

In an example implementation, the computing device may output content to its local display and may transmit and receive messages via the antenna interface 310, the network connection interface 312, telephony subsystem 332, etc. The computing device may output content to an external display device (e.g., over Wi-Fi) such as a TV or an external computing system. It will be understood that the computing device 300 is provided for example purposes only and does not limit the scope of the various implementations of the communication systems and methods.

The computing device 300 of FIG. 3 includes a central processing module (CPU) 302, where computer instructions are processed. Certain example implementations can include a display interface 304 that acts as a communication interface and provides functions for rendering video, graphics, images, and texts on the display. In certain example implementations of the disclosed technology, the display interface 304 may be directly connected to a local display, such as a touch-screen display associated with a mobile computing device. In another example implementation, the display interface 304 may be configured to provide content (for example, data, images, location data, and other information as previously discussed) for an external/remote display or mobile computing device that is not necessarily physically connected to the computing device 300. For example, a desktop monitor may be utilized for mirroring graphics and other information that is presented on a mobile computing device. In certain example implementations, the display interface 304 may wirelessly communicate, for example, via a Wi-Fi channel or other available network connection interface 312 to an external/remote display.

The network connection interface 312 may be configured as a communication interface and may provide functions for rendering video, graphics, images, text, other information, or any combination thereof on the display. In one example, the computing device 300 may include a communication interface that may include one or more of: a serial port, a parallel port, a general-purpose input and output (GPIO) port, a game port, a universal serial bus (USB), a micro-USB port, a high definition multimedia (HDMI) port, a video port, an audio port, a Bluetooth® port, a near-field communication (NFC) port, another like communication interface, or any combination thereof.

The computing device 300 may include a keyboard interface 306 that provides a communication interface to a keyboard. In one example implementation, the computing device 300 may include a pointing device interface 308 for connecting to a presence-sensitive input interface. The pointing device interface 308 may provide a communication interface to various devices such as video cameras, ingress/egress sensors, etc.

The computing device 300 may be configured to use an input device via one or more of input/output interfaces (for example, the keyboard interface 306, the display interface 304, the pointing device interface 308, the antenna interface 310, the network connection interface 312, camera interface 314, sound interface 316, etc.,) to allow a user to capture information into the computing device 300. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device 300 or may be a separate device. For example, the input device may be an accelerometer, a magnetometer, a digital camera, a microphone, and an optical sensor.

Certain example implementations of the computing device 300 may include an antenna interface 310 in communication with an antenna. The antenna interface 310 can include one or more of: a receiver, analog-to-digital converter, sampler, buffers, and memory. Certain example implementations can include a network connection interface 312 that provides a communication interface to a network.

In certain implementations, a camera interface 314 may act as a communication interface to provide functions for capturing digital images (and/or video) from a camera. In certain example implementations, the camera interface 314 may be utilized to control certain characteristics of the camera, such as focus, aperture, exposure time, burst rate, etc.

In certain implementations, a sound interface 316 is provided as a communication interface for converting sound into electrical signals using a microphone and for converting electrical signals into sound using a speaker. According to example implementations, a random-access memory (RAM) 318 is provided, where computer instructions and data may be stored in a volatile memory device for processing by the CPU 302.

According to an example implementation, the computing device 300 includes a read-only memory (ROM) 320 where invariant low-level system code or data for basic system functions such as basic input and output (I/O), startup, or reception of keystrokes from a keyboard are stored in a non-volatile memory device. According to an example implementation, the computing device 300 includes a storage medium 322 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 324, application programs 326 and content files 328 are stored.

In accordance with certain example implementations of the disclosed technology, the application programs 326 can include special-purpose software that may process location data.

According to an example implementation, the computing device 300 includes a power source 330 that provides an appropriate alternating current (AC) or direct current (DC) to power components. According to an example implementation, the computing device 300 can include a telephony subsystem 332 that allows the device 300 to transmit and receive sound over a telephone network. The constituent devices and the CPU 302 communicate with each other over a bus 334.

In accordance with an example implementation, the CPU 302 has appropriate structure to be a computer processor. In one arrangement, the computer CPU 302 may include more than one processing module. The RAM 318 interfaces with the computer bus 334 to provide quick RAM storage to the CPU 302 during the execution of software programs such as the operating system application programs, and device drivers. More specifically, the CPU 302 loads computer-executable process steps from the storage medium 322 or other media into a field of the RAM 318 in order to execute software programs. Content may be stored in the RAM 318, where the content may be accessed by the computer CPU 302 during execution. In one example configuration, the device 300 includes at least 128 MB of RAM, and 256 MB of flash memory.

The storage medium 322 itself may include a number of physical drive modules, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 300 to access computer-executable process steps, application programs and the like, stored on removable and non-removable memory media, to off-load data from the device 300 or to upload data onto the device 300. A computer program product, such as one utilizing a communication system may be tangibly embodied in storage medium 322, which may comprise a machine-readable storage medium.

According to one example implementation, the terms computing device or mobile computing device, as used herein, may be a central processing module (CPU), controller or processor, or may be conceptualized as a CPU, controller or processor (for example, the CPU processor 302 of FIG. 3). In yet other instances, a computing device may be a CPU, controller or processor combined with one or more additional hardware components. In certain example implementations, the computing device operating as a CPU, controller or processor may be operatively coupled with one or more peripheral devices, such as a display, navigation system, stereo, entertainment center, Wi-Fi access point, or the like. In another example implementation, the term computing device, as used herein, may refer to a mobile computing device, such as a smartphone, mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, satellite processor, or some other like terminology. In an example embodiment, the computing device may output content to its local display or speaker(s). In another example implementation, the computing device may output content to an external display device (e.g., over Wi-Fi) such as a TV or an external computing system.

The features and other aspects and principles of the disclosed embodiments may be implemented in various environments. Such environments and related applications may be specifically constructed for performing the various processes and operations of the disclosed embodiments or they may include a special-purpose computer or computing platform selectively activated or reconfigured by program code to provide the necessary functionality. Further, the processes disclosed herein may be implemented by a suitable combination of hardware, software, and/or firmware. For example, the disclosed embodiments may implement computing machines configured to execute software programs that perform processes consistent with the disclosed embodiments. Certain disclosed embodiments may implement a specialized apparatus or system configured to execute software programs that perform processes consistent with the disclosed embodiments. Furthermore, although some disclosed embodiments may be implemented by general-purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high-level and/or low-level software instructions, such as machine code (e.g., such as that produced by a compiler) and/or high-level code that can be executed by a processor using an interpreter.

FIG. 4A depicts an example representation of a normalized beacon signal strength 402 as a function of distance (x, y) from the beacon, according to an example implementation of the disclosed technology.

FIG. 4B depicts a top-view representation of paths 408, 410, 412 traversed near a beacon 406, according to an example implementation of the disclosed technology. Discrete measurement points 414 are represented by the “star” icons along path 410.

FIG. 4C depicts normalized signal strength measurements near a beacon as a function of the paths 408, 410, 412 illustrated in FIG. 4B, according to an example implementation of the disclosed technology, with the discrete measurement points shown corresponding to the individual signal strength measurements 414 along the path 410.

In accordance with certain example implementations of the disclosed technology, the one or more paths 408, 410, 412 traversed near the beacon 406 (which may be representative of one of the beacons 106, 108 shown in FIG. 1) may correspond to one or more location-monitored paths taken by a user (such as path 116 taken by a first user 114 and/or path 122 taken by a second user 120, as depicted in FIG. 1). The normalized signal strength measurements, as a function of the traversed paths 408, 410, 412, as shown in FIG. 4C may have respective maxima corresponding to the path's closest point to the beacon 406 where the received beacon signal is the strongest.

In certain example implementations, the signal strength measurements may be taken at individual positions along a traversed path, and each associated signal strength measurement 414 may be normalized (as previously discussed), for example, by dividing the corresponding signal strength measurements taken by a smartphone on the path, by the signal strength measured at the same time by the stationary receivers. In certain example implementations, curve fitting may be utilized to estimate a “continuous” signal-strength curve based on the normalized discrete measurements 414. According to an example implementation of the disclosed technology, estimated maxima (for example, as a result of curve fitting) and/or actual normalized maxima of the discrete RSSI measurements may be utilized along with other path maxima to estimate the location of the corresponding beacon, and the location of the asset to which the beacon is attached.

In certain example implementations, and with reference to FIG. 4B, signal strength measurements along a single path 408 may provide some information as to the approximate location of the beacon 406 (i.e., closest to the maxima), but ambiguity may exist due to the lack of any directional information. However, when measurements 414 are made along a second path 410, the (normalized) maxima for this second path may be utilized to at least partially remove the ambiguity. For example, if the second path 410 maxima is greater than the first path 408 maxima, then the system may determine that the beacon 406 is closer to the second path. As more measurements are utilized (along another path 412 for example), the accuracy of asset's estimated location may be increased. If a significant change in the location is detected (indicating asset movement) the old data can be discarded.

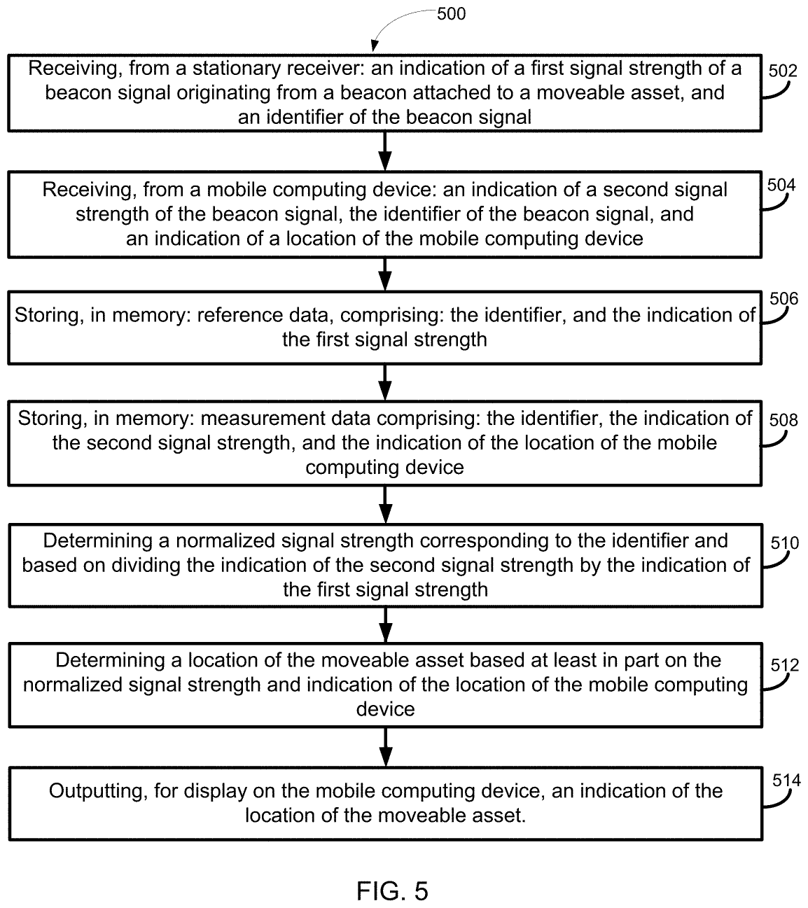

FIG. 5 is a flow diagram of a method 500 according to an example implementation of the disclosed technology. In block 502, the method 500 includes receiving, from a stationary receiver: an indication of a first signal strength of a beacon signal originating from a beacon attached to a moveable asset, and an identifier of the beacon signal. In block 504, the method 500 includes receiving, from a first mobile computing device: an indication of a second signal strength of the beacon signal, the identifier of the beacon signal, and an indication of a location of the first mobile computing device. In block 506, the method 500 includes storing, in memory: reference data, comprising: the identifier, and the indication of the first signal strength. In block 508, the method 500 includes storing, in memory: measurement data comprising: the identifier, the indication of the second signal strength, and the indication of the location of the first mobile computing device. In block 510, the method 500 includes determining a normalized signal strength corresponding to the identifier and based on dividing the indication of the second signal strength by the indication of the first signal strength. In block 512, the method 500 includes determining a location of the moveable asset based at least in part on the normalized signal strength and indication of the location of the first mobile computing device. In block 514, the method 500 includes outputting, for display on one or more of the first mobile computing device and a second mobile computing device, an indication of the location of the moveable asset.

In accordance with certain example implementations of the disclosed technology, a first user having the first mobile device may take the measurements and communicate the data to the server for storage in the database and a determination of the asset(s) location. Thereafter, a second user having the second mobile device may make a query against the database for a moveable asset of interest. When the database returns the answer, the display on the second mobile device may then show the location of the moveable asset of interest. In certain example implementations, the determined location of the moveable asset of interest may also be displayed on the first mobile computing device if the first user submits a query to the database for the location of the same moveable asset of interest.

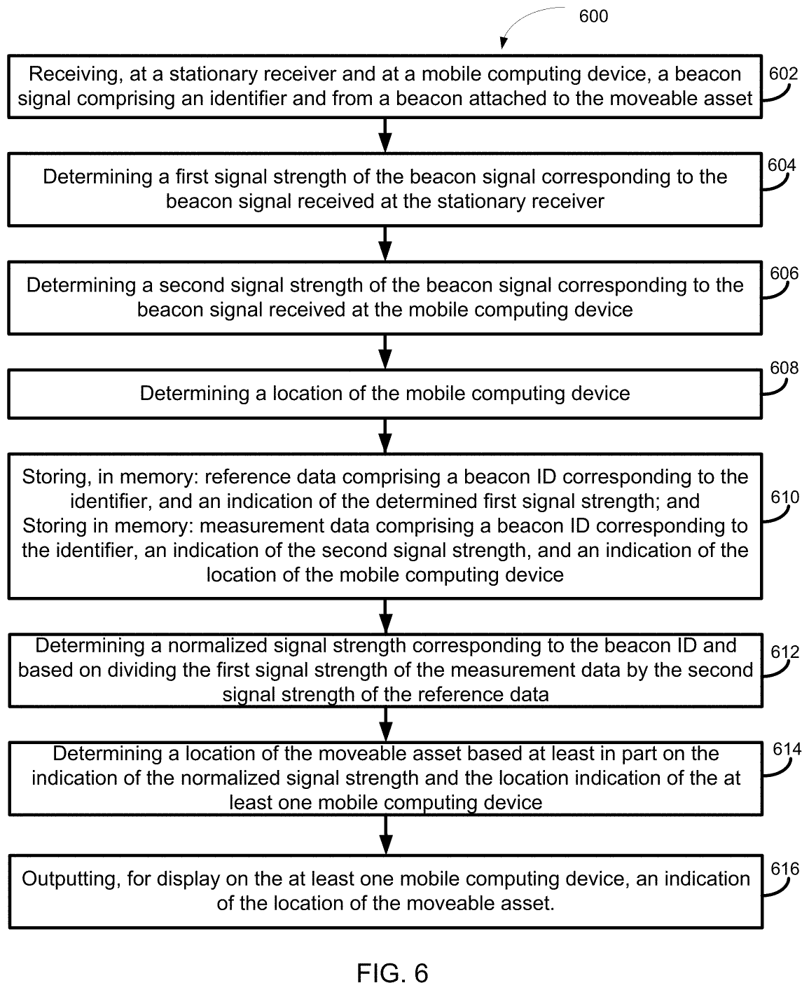

FIG. 6 is a flow diagram of a method 600 according to an example implementation of the disclosed technology. In block 602, the method 600 includes receiving, at a stationary receiver and at a first mobile computing device, a beacon signal comprising an identifier and from a beacon attached to the moveable asset. In block 604, the method 600 includes determining a first signal strength of the beacon signal corresponding to the beacon signal received at the stationary receiver. In block 606, the method 600 includes determining a second signal strength of the beacon signal corresponding to the beacon signal received at the first mobile computing device. In block 608, the method 600 includes determining a location of the first mobile computing device. In block 610, the method 600 includes storing, in memory: reference data comprising a beacon ID corresponding to the identifier, and an indication of the determined first signal strength; and storing in memory: measurement data comprising a beacon ID corresponding to the identifier, an indication of the second signal strength, and an indication of the location of the first mobile computing device. In block 612, the method 600 includes determining a normalized signal strength corresponding to the beacon ID and based on dividing the first signal strength of the measurement data by the second signal strength of the reference data. In block 614, the method 600 includes determining a location of the moveable asset based at least in part on the indication of the normalized signal strength and the location indication of the first mobile computing device. In block 614, the method 600 includes outputting, for display on one or more of the first mobile computing device and a second mobile computing device, an indication of the location of the moveable asset.

Certain example implementations of the disclosed technology can include low pass filtering the beacon signal to produce the indication of the first signal strength and/or the second signal strength to reduce beacon signal transients.

In certain example implementations, the first and second indications of signal strength are RSSI, and wherein the identifier comprises a Universally Unique Identifier (UUID). In accordance with certain example implementations of the disclosed technology, one beacon may be configured to broadcast a VIN of a vehicle, while a second beacon may broadcast the UUID so that the system may distinguish raw data from data that has been normalized.

Certain example implementations of the disclosed technology include retrieving previously determined location information corresponding to the identifier from memory and refining the location of the moveable asset based at least in part on the previously determined location information.

In certain example implementations, the previously determined location information is discarded responsive to a detected change in the location of the moveable asset above a predetermined distance.

In certain example implementations, determining the location of the moveable asset is based on a distribution of location indications comprising one or more of: the indication of the location of the moveable asset; and previously determined location information corresponding to the identifier.

While each of the location determining functions, as discussed above, may be separately processed as data arrives, certain example implementations of the disclosed technology may process the historical measurement data with incoming new data, for example, to improve performance, stability, and/or speed of the location determination process.

According to an example implementation of the disclosed technology, asset location information requested by a user may be provided in the form of the user's location relative to a determined location for that particular asset.

Certain example implementations of the disclosed technology may utilize crowdsourcing to update the beacon estimated location, for example, so that multiple users walking around the lot can provide data points.

While certain previous systems and methods may provide information about a user's mobile computing device location based on signals received from stationary beacons, certain embodiments of the disclosed technology instead provide a different function whereby a location of a beacon attached to a moveable asset may be estimated using known locations of a user's mobile computing device. Furthermore, as discussed above, certain example implementations of the disclosed technology may utilize stationary receivers to provide a reference signal strength measurement to further increase the location accuracy.

The systems and methods disclosed herein may provide the technical effect of increasing asset location accuracy via crowdsourcing compared to the location accuracy determined by measurements along a single path or by a single user.

The systems and methods disclosed herein may take advantage of modern computer architecture for significant improvements in object recognition. As used in this application, the terms “component,” “module,” “system,” “server,” “processor,” “memory,” and the like are intended to include one or more computer-related modules, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Exemplary Use Cases

In one exemplary use case, a user may be shopping for a vehicle, and may be walking around a dealer lot attempting to find a particular vehicle (e.g., vehicle 102). The user may access the dealer's inventory web application with their mobile computing device (e.g., smartphone 112), search for the vehicle of interest, and receive detailed directions (e.g., via smartphone 112 at the direction of asset location server 204) on where the vehicle is currently located based on previously processed crowdsourced information and location estimates, as described herein. In certain example implementations, additional vehicle information (besides location information) can be sent to the user's mobile computing device (e.g., smartphone 112), including: make, model number, year, features, comparative pricing, etc. In accordance with certain example implementations of the disclosed technology, when the customer accesses the dealer's web application to retrieve such vehicle information, the customer may be prompted (e.g., via smartphone 112 at the direction of asset location server 204) to opt-in, for example, to allow their mobile device to measure signal strengths of beacons on the lot and provide their associated GPS coordinates so that they can also help crowdsource the vehicle locations.

Certain example implementations of the disclosed technology may utilize location information (such as GPS coordinates, geofencing, etc.) to provide additional or refined location information. For example, a GPS receiver on the user's mobile computing device (e.g., smartphone 112) may be utilized to determine (e.g., via asset location server 204) an approximate location of the user for refined directions to a particular vehicle (e.g., vehicle 102). In the example use case scenario where the user is located at a vehicle dealership lot, the user's location may be utilized to present information about vehicles that are closest to the user. In another example scenario, signage, QR codes, barcodes, emblems, and/or other identifying features near or attached to the vehicle may be utilized to locate a particular vehicle with high confidence.

1. A system for tracking a moveable asset, comprising:
a short-range wireless beacon attached to the moveable asset, wherein the beacon is configured to periodically transmit a beacon signal comprising an identifier that identifies the moveable asset;
at least one stationary receiver configured to:
receive the beacon signal;
determine a first signal strength of the beacon signal corresponding to the beacon signal received at the stationary receiver; and
output reference data, comprising:
a beacon ID corresponding to the identifier; and
an indication of the determined first signal strength;
a first mobile computing device configured to:
receive the beacon signal;
determine a second signal strength of the beacon signal corresponding to the beacon signal received at the first mobile computing device;
determine GPS coordinates of the first mobile computing device; and
output measurement data comprising:
a beacon ID corresponding to the identifier;
an indication of the second signal strength; and
an indication of the GPS coordinates of the first mobile computing device;
a signal strength measurement module comprising at least one processor in communication with memory and further in communication with the at least one stationary receiver and the at least one mobile receiver, and configured to:
receive the reference data;
receive the measurement data;
determine, with the at least one processor, an indication of normalized signal strength corresponding to the beacon ID and based on dividing the signal strength of the measurement data by the signal strength of the reference data; and
an asset location module in communication with the signal strength measurement module and the at least one processor, the asset location module configured to:
receive a plurality of normalized signal strength measurements taken at individual positions along a traversed path of the first mobile computing device;
determine a signal-strength curve based on the plurality of normalized signal strength measurements and based on the signals received from the beacon;
determine, with the at least one processor, a location of the moveable asset based at least in part on the signal-strength curve and the GPS coordinates; and
output, for display on one or more of the first mobile computing device and a second mobile computing device, an indication of the location of the moveable asset.

2. The system of claim 1, wherein the stationary receiver further comprises a first low pass filter, and the first signal strength is determined, at least in part, by low pass filtering the received beacon signal with the first low pass filter to reduce beacon signal transients.

3. The system of claim 1, wherein the first mobile computing device further comprises a second low pass filter, and the second signal strength is determined, at least in part, by low pass filtering the received beacon signal with the second low pass filter to reduce beacon signal transients.

4. The system of claim 1, wherein the beacon is a battery powered Bluetooth® transmitter, the signal strength indication signal is RSSI, and the identifier of the beacon signal comprises a Universally Unique Identifier (UUID).

5. The system of claim 1, wherein the identifier is the beacon ID.

6. The system of claim 1, wherein the asset location module is further configured to retrieve previously determined location information corresponding to the beacon ID from the memory, and the asset location module is configured to refine the location of the moveable asset based at least in part on the previously determined location information and a new location based on the maxima of the signal strength curve, wherein the maxima corresponds to the traversed path's closest point to the beacon where the received beacon signal is the strongest.

7. The system of claim 6, wherein the previously determined location information is discarded responsive to a detected change in the location of the moveable asset above a predetermined distance.

8. The system of claim 1, wherein the asset location module is configured to determine the location of the moveable asset based on a distribution of location indications comprising one or more of:
the indication of the location of the moveable asset; and
previously determined location information corresponding to the beacon ID.

9. A method for tracking a moveable asset, comprising:
receiving, from a stationary receiver:
a plurality of indications of a first signal strength of a beacon signal originating from a short-range wireless beacon attached to a moveable asset; and
an identifier of the beacon signal;
receiving, from a first mobile computing device:
a plurality of indications of a second signal strength of the beacon signal;
the identifier of the beacon signal; and
a plurality of indications of GPS coordinates of the first mobile computing device;
storing, in memory:
reference data, comprising:
the identifier; and
the plurality of indications-of the first signal strength; and
measurement data comprising:
the identifier;
the plurality of indications of the second signal strength; and
the plurality of indications of GPS coordinates of the first mobile computing device;
determining a plurality of normalized signal strengths corresponding to the identifier and based on dividing the plurality of indications of the second signal strength by the plurality of indications of the first signal strength;
determine a signal strength curve based on the plurality of normalized signal strengths and based on the signals received from the beacon;
determining a location of the moveable asset based at least in part on the signal strength curve and the GPS coordinates; and
outputting, for display on one or more of the first mobile computing device and a second mobile computing device, an indication of the location of the moveable asset.

10. The method of claim 9, further comprising low pass filtering the beacon signal to produce the indication of the first signal strength to reduce beacon signal transients.

11. The method of claim 9, further comprising low pass filtering the beacon signal to produce the indication of the second signal strength to reduce beacon signal transients

12. The method of claim 9, wherein the first and second indications of signal strength are RSSI, and wherein the identifier comprises a Universally Unique Identifier (UUID).

13. The method of claim 9, further comprising retrieving previously determined location information corresponding to the identifier from memory and refining the location of the moveable asset based at least in part on the previously determined location information and a new location based on the maxima of the signal strength curve, wherein the maxima corresponds to the traversed path's closest point to the beacon where the received beacon signal is the strongest.

14. The method of claim 13, wherein the previously determined location information is discarded responsive to a detected change in the location of the moveable asset above a predetermined distance.

15. The method of claim 9, wherein determining the location of the moveable asset is based on a distribution of location indications comprising one or more of:
the indication of the location of the moveable asset; and
previously determined location information corresponding to the identifier.

16. A non-transitory computer readable storage medium storing instructions for use with a moveable asset locator system, wherein the instructions are configured to cause the system to perform a method comprising:
receiving, from a stationary receiver:
a plurality of indications of a first signal strength of a beacon signal originating from a short-range wireless beacon attached to a moveable asset; and
an identifier of the beacon signal;
receiving, from a first mobile computing device:
a plurality of indications of a second signal strength of the beacon signal;
the identifier of the beacon signal; and
a plurality of indications of GPS coordinates of the first mobile computing device;
storing, in memory:
reference data, comprising:
the identifier; and
the plurality of indications of the first signal strength; and
measurement data comprising:
the identifier;
the plurality of indications of the second signal strength; and
the plurality of indications of GPS coordinates of the first mobile computing device;
determining a plurality of normalized signal strengths corresponding to the identifier and based on dividing the plurality of indications of the second signal strength by the plurality of indications of the first signal strength;
determine a signal strength curve based on the plurality of normalized signal strengths and based on the signals received from the beacon;
determining a location of the moveable asset based at least in part on the signal strength curve and the GPS coordinates; and
outputting, for display on one or more of the first mobile computing device and a second mobile computing device, an indication of the location of the moveable asset.

17. The non-transitory computer readable storage medium of claim 16, further comprising retrieving previously determined location information corresponding to the identifier from memory and refining the location of the moveable asset based at least in part on the previously determined location information.

18. The non-transitory computer readable storage medium of claim 17, wherein the previously determined location information is discarded responsive to a detected change in the location of the moveable asset above a predetermined distance.

19. The non-transitory computer readable storage medium of claim 16, wherein determining the location of the moveable asset is based on a distribution of location indications comprising one or more of:
the indication of the location of the moveable asset; and
previously determined location information corresponding to the identifier.

20. A method for tracking a moveable asset, comprising:
receiving, at a stationary receiver and at a first mobile computing device, a plurality of beacon signals comprising an identifier and from a short-range wireless beacon attached to the moveable asset;
determining a plurality of first signal strengths of the plurality of beacon signals corresponding to the plurality of beacon signals received at the stationary receiver;
determining a plurality of second signal strengths of the beacon signal corresponding to the plurality of beacon signals received at the first mobile computing device;
determining a corresponding plurality of GPS coordinates of the first mobile computing device; and
storing, in memory:
reference data, comprising:
a beacon ID corresponding to the identifier; and
a plurality of indications corresponding to the determined plurality of first signal strengths; and
measurement data comprising:
a beacon ID corresponding to the identifier;
a plurality of indications corresponding to the determined plurality of second signal strengths; and
a plurality of indications corresponding to the plurality of GPS coordinates of the first mobile computing device;
determining a plurality of normalized signal strengths corresponding to the beacon ID and based on dividing the plurality of second signal strengths of the measurement data by the plurality of first signal strengths of the reference data;
determine a continuous signal strength curve based on the plurality of normalized signal strengths and the plurality of GPS coordinates;
determining a location of the moveable asset based at least in part on the continuous signal strength curve and the GPS coordinates; and
outputting, for display on one or more of the first mobile computing device and a second mobile computing device, an indication of the location of the moveable asset.
